(19) United States
(12) Patent Application Publication
(10) Pub. No.: US 2025/0283364 A1
(43) Pub. Date: Sep. 11, 2025

(54) VEHICLE DOOR SYSTEM AND METHOD FOR OPERATING A VEHICLE DOOR SYSTEM

(71) Applicants: Ningbo Geely Automobile Research & Development Co., Ltd., Ningbo (CN); Zhejiang Geely Holding Group Co., Ltd., Zhejiang (CN)

(72) Inventors: Fredrik WALLANDER, Pixbo (SE); Kaj ANDERSSON, Mellerud (SE); Bengt LENNARTSSON, Partille (SE)

(21) Appl. No.: 19/218,329

(22) Filed: May 25, 2025

Related U.S. Application Data
(63) Continuation of application No. PCT/CN2023/138689, filed on Dec. 14, 2023.

(30) Foreign Application Priority Data
Dec. 21, 2022 (EP) 22215562

(51) Int. Cl. E05D 15/34; B60J 5/06; B62D 25/02

(52) U.S. Cl. CPC E05D 15/34; B60J 5/06; B62D 25/025

(57) ABSTRACT

A vehicle door system has a door structure movable relative to a vehicle body between closed and open positions. The door structure is connected to the vehicle body via first and second arms arranged at a lower end of the door structure. The first arm includes a first inner end pivotably connected to the vehicle body and a first outer end pivotably connected to the door structure. The second arm includes a second inner end pivotably connected to the vehicle body and a second outer end pivotably connected to the door structure. The first arm has an inner arm section and an outer arm section pivotably connected to each other via an intermediate pivot point. The inner arm section and the outer arm section are pivotably displaceable relative to each other via the intermediate pivot point upon displacement of the door structure between the closed and open positions.

### RELATED APPLICATION DATA

This application is a continuation of International Patent Application No. PCT/CN2023/138689, filed Dec. 14, 2023, and claims the benefit of European Patent Application No. 22215562.4, filed Dec. 21, 2022, the disclosures of which are incorporated herein by reference in their entireties.

### TECHNICAL FIELD

The present disclosure relates to a vehicle door system. The vehicle door system comprises a door structure movably arranged relative to a vehicle body structure between a closed door position and an open door position. The door structure is connected to the vehicle body structure via a first arm and a second arm. The disclosure further relates to a method for operating a vehicle door system.

### BACKGROUND

Vehicle door systems are used for covering an opening of a vehicle body structure, where the opening leads to an interior compartment of the vehicle. The door systems generally comprise a displacement mechanism configured for displacing a door structure in relation to the opening between a closed door position and open door positions.

Traditionally, hinged door structures are used, where the door structure is connected to the vehicle body structure via hinges or similar arrangements, and displaced in relation to the vehicle body structure between open and closed positions by a swinging movement. Traditional hinged door systems are simple in construction but require a relatively large space outside the vehicle when being fully opened.

Sliding door structures are becoming more popular and are instead mounted to or suspended in relation to the vehicle body structure via a track system, or a combined track and hinge system. The sliding door structures are displaced in relation to the vehicle body structure between open and closed positions, by a sliding movement horizontally alongside the vehicle body structure. Sliding door systems and other alternative door systems have the advantage with smaller space needed for the opening and closing of the door compared to a hinged door solution. Current sliding door system solutions commonly use a mechanism in the sill area, which increases the height of the sill so that the step-over height for entering the interior compartment of the vehicle is higher than that of traditional hinged door systems. There is further a problem with sliding doors in that the sliding movement of the door is restricted by the mechanism.

Door structures that are connected to the vehicle body structure with arms may be used as an alternative to sliding doors, where the arms are moved relative to the door structure and the vehicle body structure upon displacement of the vehicle door between the closed and open door positions. When using movable arms, there may be issues with efficient opening and closing of the door structure, especially if the door structure is arranged in direct connection to another door structure. Such arrangements may be used if the vehicle is arranged with large openings having no supporting B-pillar. In some cases, a front door needs to be opened first in order for the rear door to be opened, due to an overlapping construction of the doors. Such overlapping may be needed due to crash requirements. There is thus a need for an improved door system having movable arms, where the door structure can be efficiently opened and closed, and is allowing arrangement of the door structure in connection to another door structure with improved opening geometry and kinematics, where both door structures can be opened and closed independently.

### SUMMARY

An object of the present disclosure is to provide a vehicle door system, a vehicle comprising a vehicle door system, and a method for operating a vehicle door system, where the previously mentioned problems are avoided.

The disclosure concerns a vehicle door system comprising a door structure movably arranged relative to a vehicle body structure between a closed door position and an open door position. The door structure is connected to the vehicle body structure via a first arm and a second arm. The first arm and the second arm are arranged at a lower end of the door structure. The first arm comprises a first inner end pivotably connected to the vehicle body structure and a first outer end pivotably connected to the door structure. The second arm comprises a second inner end pivotably connected to the vehicle body structure and a second outer end pivotably connected to the door structure. The first arm comprises an inner arm section and an outer arm section pivotably connected to each other via an intermediate pivot point. The inner arm section and the outer arm section are configured for being pivotably displaced relative to each other via the intermediate pivot point upon displacement of the door structure between the closed door position and the open door position.

Advantages with these features are that the vehicle door system is allowing opening and closing of the door structure relative to the vehicle body structure with a small space compared to traditional door solutions. The pivoting arrangement of the first arm with the inner arm section and outer arm section is enabling an efficient door opening and closing geometry. The solution is enabling independent door opening and closing abilities when two door structures are arranged in connection to each other by the arrangement of the first arm having the inner arm section and the outer arm section pivotably connected to each other via the intermediate pivot point. The pivoting connection is used for a compact displacement of the door structure with improved geometry, where the door structure can be efficiently opened and closed. The door structure is suitably used in connection to another door structure, where both door structures can be opened and closed independently by the design of the first arm with the intermediate pivot point.

In one embodiment, in the closed door position, the inner arm section and the outer arm section are arranged relative to each other in an extended state. In the open door position, the inner arm section and the outer arm section are arranged relative to each other in an angled state. The inner arm section and the outer arm section are configured for pivoting around the intermediate pivot point when displaced between the extended state and the angled state. When opening the door structure from the closed door position, the inner arm section and the outer arm section are pivoted relative to each other around the intermediate pivot point from the extended state to the angled state. When closing the door structure, the inner arm section and the outer arm section are pivoting around the intermediate pivot point from the angled state to the extended state. This is enabling an efficient door opening and door closing geometry.

In one embodiment, in the extended state the angular relationship between the inner arm section and the outer arm section is greater than the angular relationship between the inner arm section and the outer arm section in the angled state. The angular relationship may be defined as a relative angle measured between the inner arm section and the outer arm section.

In one embodiment, the intermediate pivot point is arranged as a spring-loaded pivoting point comprising a spring member. The spring member is used for an efficient operation of the first arm, where the inner arm section and the outer arm section are pivotably displaced relative to each other via the intermediate pivot point upon displacement of the door structure between the closed door position and the open door position.

In one embodiment, upon displacement of the door structure from the closed door position to the open door position, the outer arm section is configured for being folded towards the inner arm section around the intermediate pivot point by means of spring action from the spring member. Upon displacement of the door structure from the open door position to the closed door position, the outer arm section is configured for being folded away from the inner arm section around the intermediate pivot point.

In one embodiment, a spring pre-tension of the spring member is greater in the closed door position than in the open door position. Upon displacement of the door structure from the closed door position to the open door position, the spring pre-tension is enabling a folding movement of the outer arm section towards the inner arm section around the intermediate pivot point by means of spring action from the spring member. Upon displacement of the door structure from the open door position to the closed door position, the spring pre-tension of the spring member is built up by the movement of the door structure, when the first arm is stretched out to the extended state. In this way, the spring pre-tension of the spring member is built up to be greater in the closed door position than in the open door positions through the pivoting movement of the outer arm section and the inner arm section relative to each other around the intermediate pivot point.

In one embodiment, the inner arm section is extending from the first inner end to the intermediate pivot point, and the outer arm section is extending from the intermediate pivot point to the first outer end.

In one embodiment, the first inner end is pivotably connected to the vehicle body structure via a first inner pivot point and the first outer end is pivotably connected to the door structure via a first outer pivot point. The first arm is configured for pivoting around the first inner pivot point and the first outer pivot point upon displacement of the door structure between the closed door position and the open door position. The second inner end is pivotably connected to the vehicle body structure via a second inner pivot point and the second outer end is pivotably connected to the door structure via a second outer pivot point. The second arm is configured for pivoting around the second inner pivot point and the second outer pivot point upon displacement of the door structure between the closed door position and the open door position. The first inner pivot point and the first outer pivot point may be arranged as shafts or axle structures around which the first arm is allowed to pivot upon displacement of the door structure relative to the vehicle body structure. The second inner pivot point and the second outer pivot point may be arranged as shafts or axle structures around which the second arm is allowed to pivot upon displacement of the door structure relative to the vehicle body structure. The shafts or axle structures are suitably arranged in a holding structure or similar arrangement attached to the vehicle body structure and the door structure respectively.

In one embodiment, the first inner pivot point and the second inner pivot point are non-slidingly arranged relative to the vehicle body structure, and the first outer pivot point and the second outer pivot point are non-slidingly arranged relative to the door structure. In this way, the door structure is efficiently displaced relative to the vehicle body structure only through pivoting movements.

In one embodiment, the first inner end and the second inner end are pivotably connected to a side sill structure forming part of the vehicle body structure.

In embodiments, the first arm is arranged forwards of the second arm, or the first arm is arranged rearwards of the second arm. When the door structure is arranged as a rear door, the first arm is suitably arranged forwards of the second arm for an efficient opening and closing geometry of the door structure. In other vehicle door configurations, the first arm may instead be arranged rearwards of the second arm.

In one embodiment, the lower end of the door structure further comprises a lower steering pin arranged in connection to the first arm. The lower steering pin is configured for engaging a lower slot arranged in the vehicle body structure upon initial displacement of the door structure from the closed door position to the open door position and upon final displacement of the door structure from the open door position to the closed door position. When opening the door structure, the lower steering pin is guiding the initial opening movement of the door structure when displaced from the closed door position. In this way, the movement of the door structure is controlled through the interaction between the lower steering pin and the lower slot. The slot may have straight or curved configurations depending on the design and construction of the vehicle door system. The lower steering pin and the lower slot are interacting for controlling the initial movement when opening the door structure and the final movement when closing the door structure for securing alignment between the door structure and the vehicle body structure. The lower steering pin and lower slot are thus used for a controlled displacement of the door structure, and together with the pivoting movement of the inner arm section and the outer arm section around the intermediate pivot point the movement of the door structure is efficiently steered. The lower steering pin and the lower slot may also be used for an efficient locking of the door structure to the vehicle body structure in the closed door position, and suitable locking means may be provided for an efficient locking operation.

In one embodiment, an upper end of the door structure further comprises an upper steering pin. The upper steering pin is configured for engaging an upper slot arranged in the vehicle body structure upon initial displacement of the door structure from the closed door position to the open door position and upon final displacement of the door structure from the open door position to the closed door position. When opening the door structure, the upper steering pin is guiding the initial opening movement of the door structure when displaced from the closed door position. In this way, the movement of the door structure is controlled through the interaction between the upper steering pin and the upper slot. The slot may have straight or curved configurations depending on the design and construction of the vehicle door system. The upper steering pin and the upper slot are interacting for controlling the initial movement when opening the door structure and the final movement when closing the door structure for securing alignment between the door structure and the vehicle body structure. The upper steering pin and upper slot are thus used for a controlled displacement of the door structure, and together with the pivoting movement of the inner arm section and the outer arm section around the intermediate pivot point, the movement of the door structure is efficiently guided. The upper steering pin and the upper slot may also be used for an efficient locking of the door structure to the vehicle body structure in the closed door position, and suitable locking means may be provided for an efficient locking operation.

The disclosure further concerns a vehicle comprising a vehicle door system as described above.

The disclosure further concerns a method for operating a vehicle door system comprising a door structure movably arranged relative to a vehicle body structure between a closed door position and an open door position. The door structure is connected to the vehicle body structure via a first arm and a second arm. The first arm and the second arm are arranged at a lower end of the door structure. The first arm comprises a first inner end pivotably connected to the vehicle body structure and a first outer end pivotably connected to the door structure. The second arm comprises a second inner end pivotably connected to the vehicle body structure and a second outer end pivotably connected to the door structure. The first arm comprises an inner arm section and an outer arm section pivotably connected to each other via an intermediate pivot point. The method comprises the step: pivotably displacing the inner arm section and the outer arm section relative to each other via the intermediate pivot point upon displacement of the door structure between the closed door position and the open door position.

Advantages with method are that the vehicle door system is allowing opening and closing of the door structure relative to the vehicle body structure with a small space compared to traditional door solutions. The pivoting arrangement of the first arm with the inner arm section and outer arm section is enabling an efficient door opening and closing geometry. The pivoting connection is used for a compact displacement of the door structure with improved geometry, where the door structure can be efficiently opened and closed. The door structure is suitably used in connection to another door structure, where both door structures can be opened and closed independently by the first arm with the intermediate pivot point.

### BRIEF DESCRIPTION OF THE DRAWINGS

The disclosure will be described in detail in the following, with reference to the attached drawings, in which

FIGS. 1A-1B show schematically, in side views, a vehicle having a vehicle door system with a door structure arranged in a closed door position and in an open door position,

FIGS. 2A-2C show schematically, in inner side views, the vehicle door system with the door structure arranged in the closed door position and in open door positions,

FIGS. 3A-3C show schematically, in views from above, the vehicle door system with the door structure arranged in the closed door position and in open door positions, and

FIGS. 4A-4C show schematically, in views from above, a first arm of the door structure having an inner arm section and an outer arm section, in the closed door position and in open door positions.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

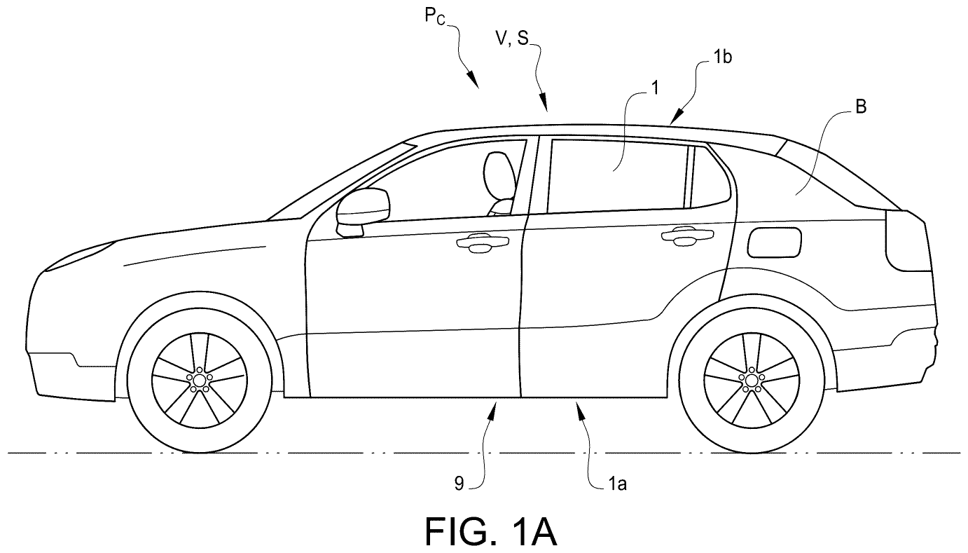

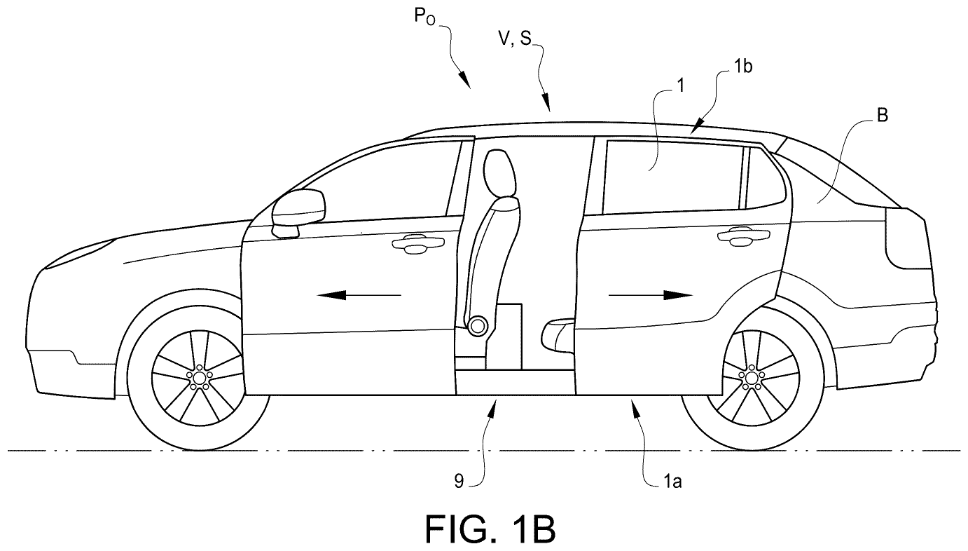

FIGS. 1A-1B schematically show a vehicle V comprising a vehicle door system S. The vehicle door system S comprises door structures 1 movably arranged relative to a vehicle body structure B of the vehicle V. The vehicle door system S will be described in connection to a door structure 1 arranged as a rear side door of the vehicle V, as illustrated in the figures. It should however be understood that the configuration of the door structure 1 may be applicable on other door structures of the vehicle V, such as a door structure 1 arranged as a front side door.

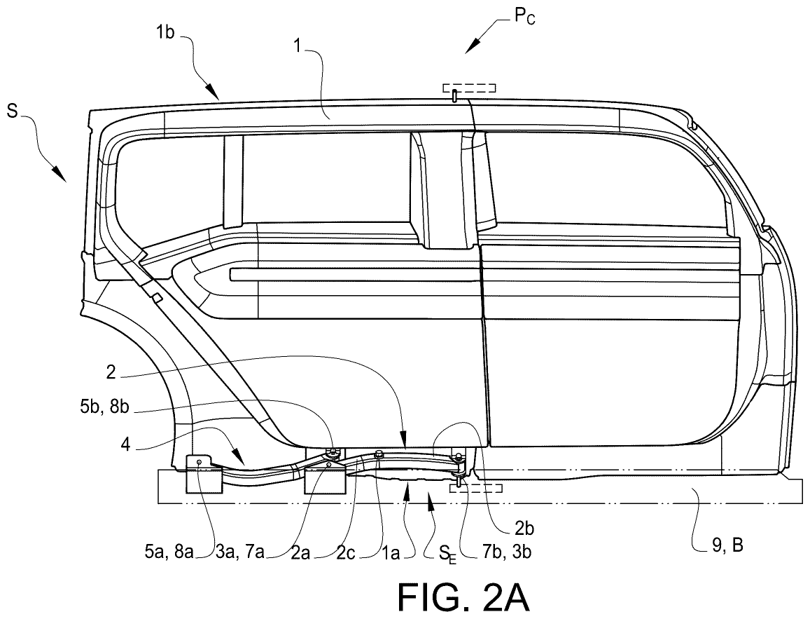

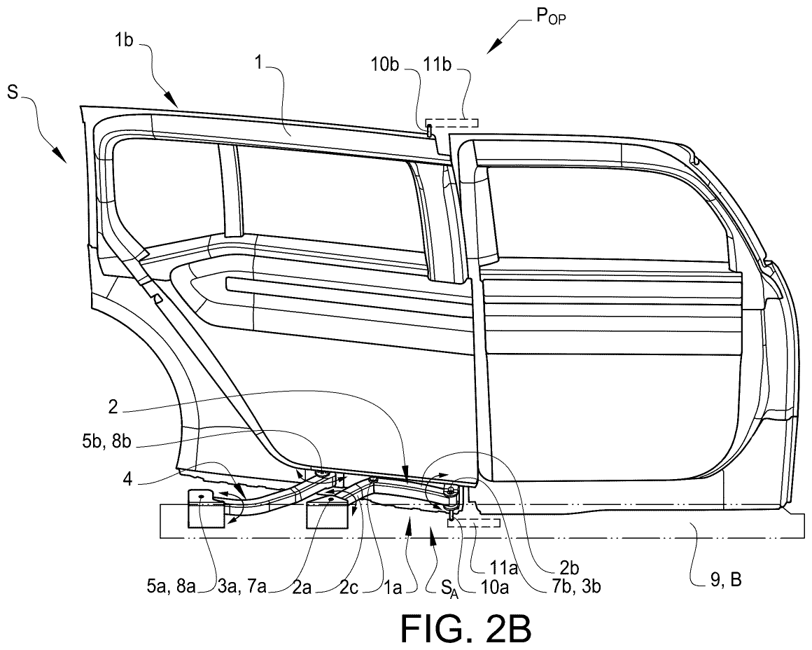

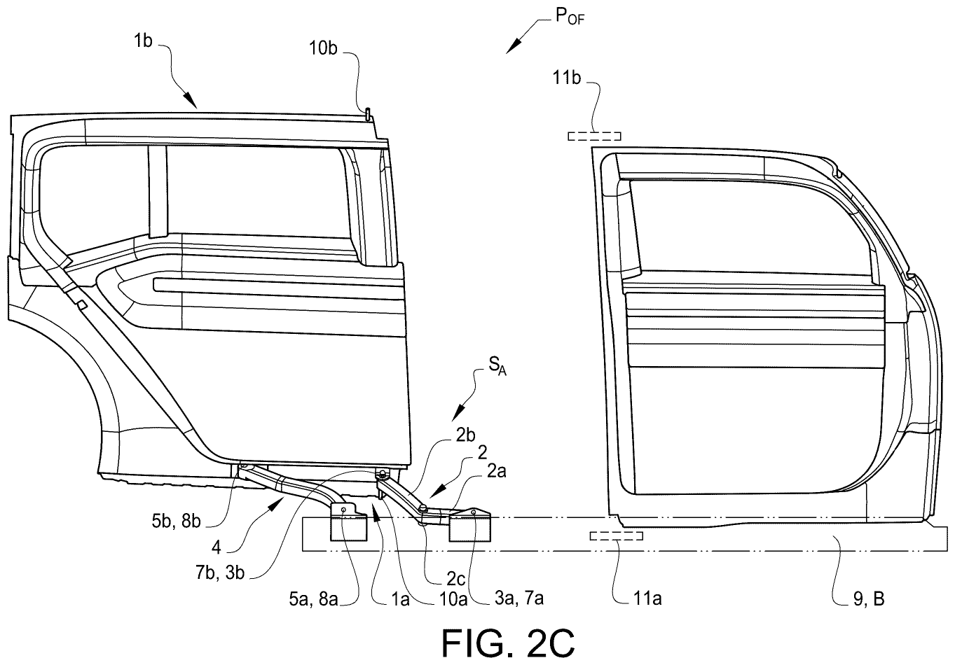

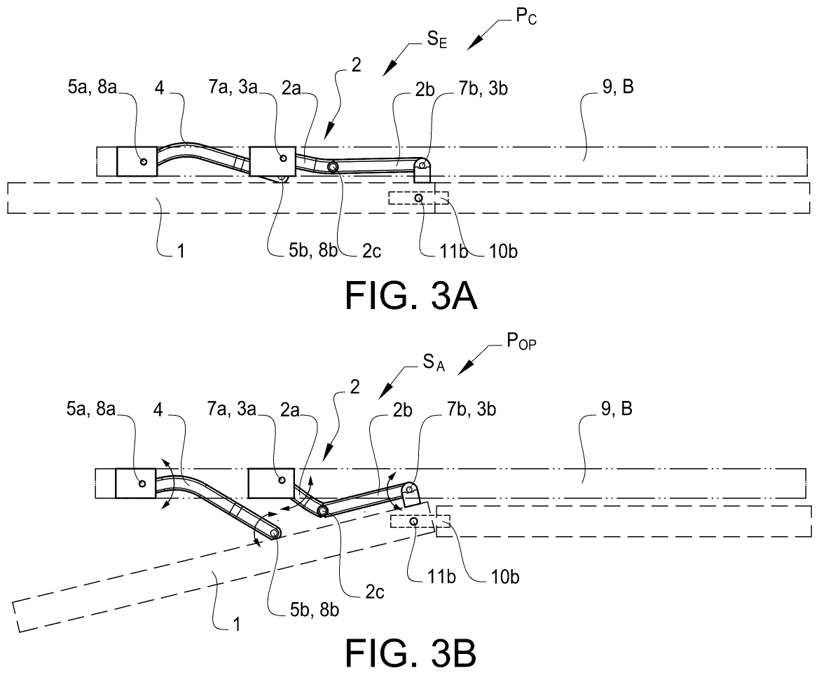

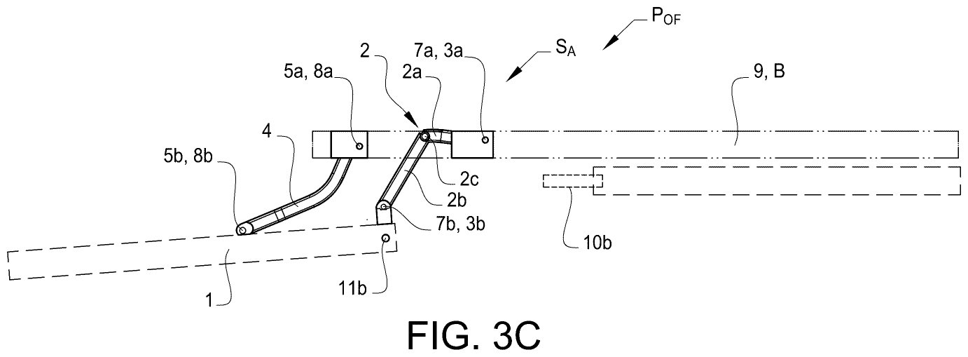

In FIG. 1A, the door structure 1 is arranged in a closed door position P_{C}, and in FIG. 1B, the door structure 1 is arranged in an open door position P_{O}. The vehicle door structure 1 is movably arranged relative to the vehicle body structure B between the closed door position P_{C} and open door positions P_{O}. Any position in which the door structure 1 has been displaced away from the closed door position P_{C} may be considered an open door position P_{O}, such as a partly open door position or a fully open door position. A closed door position P_{C} of the door structure 1 is schematically shown in FIGS. 2A and 3A, a partly open door position P_{OP} of the door structure 1 is schematically shown in FIGS. 2B and 3B, and a fully open door position P_{OF} of the door structure 1 is schematically shown in FIGS. 2C and 3C.

The door structure 1 is connected to the vehicle body structure B via a first arm 2 and a second arm 4, as shown in FIGS. 2A-2C and 3A-3C. The first arm 2 and the second arm 4 are arranged at a lower end 1a of the door structure 1. The first arm 2 and the second arm 4 are moved relative to the door structure 1 and the vehicle body structure B upon displacement of the door structure 1 between the closed door position P_{C} and the open door positions P_{O}. The movable first arm 2 and second arm 4 are providing an efficient opening and closing of the door structure 1. In the shown embodiment, the door structure 1 is arranged as a rear door structure in direct connection to a front door structure and the vehicle V is arranged with a large door opening having no supporting B-pillar, as understood from FIG. 1B.

In the illustrated embodiment, where the door structure 1 is arranged as a rear door, the first arm 2 is arranged forwards of the second arm 4. In other non-illustrated embodiments, the first arm 2 may instead be arranged rearwards of the second arm 4.

The first arm 2 comprises a first inner end 3a pivotably connected to the vehicle body structure B and a first outer end 3b pivotably connected to the door structure 1, as shown in FIGS. 2A-2C and 3A-3C. The first arm 2 is in this way pivotably arranged relative to both the door structure 1 and the vehicle body structure B, as indicated with arrows in FIGS. 2B and 3B. The first inner end 3a is pivotably connected to the vehicle body structure B via a first inner pivot point 7a and the first outer end 3b is pivotably connected to the door structure 1 via a first outer pivot point 7b. Suitably, the first inner end 3a is pivotably connected to a side sill structure 9 forming part of the vehicle body structure B. The first arm 2 is configured for pivoting around the first inner pivot point 7a and the first outer pivot point 7b upon displacement of the door structure 1 between the closed door position P_{C} and the open door positions P_{O}. The first inner pivot point 7a and the first outer pivot point 7b are suitably arranged as shafts or axle structures around which the first arm 2 is allowed to pivot upon displacement of the door structure 1 relative to the vehicle body structure B. The shafts or axle structures are suitably arranged in a holding structure or similar arrangement attached to the vehicle body structure B and the door structure 1 respectively.

The second arm 4 comprises a second inner end 5a pivotably connected to the vehicle body structure B and a second outer end 5b pivotably connected to the door structure 1, as shown in FIGS. 2A-2C and 3A-3C. The second arm 4 is in this way pivotably arranged relative to both the door structure 1 and the vehicle body structure B, as indicated with arrows in FIGS. 2B and 3B. The second inner end 5a is pivotably connected to the vehicle body structure B via a second inner pivot point 8a and the second outer end 5b is pivotably connected to the door structure 1 via a second outer pivot point 8b. Suitably, the second inner end 5a is pivotably connected to a side sill structure 9 forming part of the vehicle body structure B. The second arm 4 is configured for pivoting around the second inner pivot point 8a and the second outer pivot point 8b upon displacement of the door structure 1 between the closed door position P_{C} and the open door positions P_{O}. The second inner pivot point 8a and the second outer pivot point 8b are suitably arranged as shafts or axle structures around which the second arm 4 is allowed to pivot upon displacement of the door structure 1 relative to the vehicle body structure B. The shafts or axle structures are suitably arranged in a holding structure or similar arrangement attached to the vehicle body structure B and the door structure 1 respectively.

The first arm 2 comprises an inner arm section 2a and an outer arm section 2b pivotably connected to each other via an intermediate pivot point 2c, as shown in FIGS. 2A-2C, 3A-3C and 4A-4C. The inner arm section 2a and the outer arm section 2b are in this way configured for being pivotably displaced relative to each other via the intermediate pivot point 2c upon displacement of the door structure 1 between the closed door position P_{C} and the open door positions P_{O}. The intermediate pivot point 2c is suitably arranged as a shaft or axle structure around which the inner arm section 2a and outer arm section 2b are allowed to pivot relative each other upon displacement of the door structure 1, as will be further described below. The pivoting arrangement of the first arm 2 with the inner arm section 2a and outer arm section 2b is enabling an efficient door opening and closing geometry, where the door structure 1 can be displaced independently relative to the vehicle body structure B without interfering with adjacent door structures or other parts when opened and closed. The pivoting arrangement is further securing that the door structure can be opened without large space outside the door structure 1 needed for the opening and closing operations.

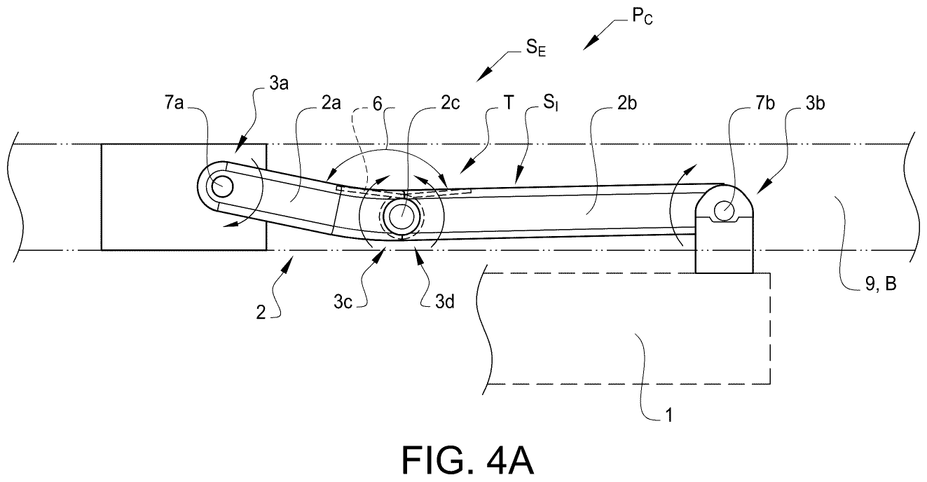

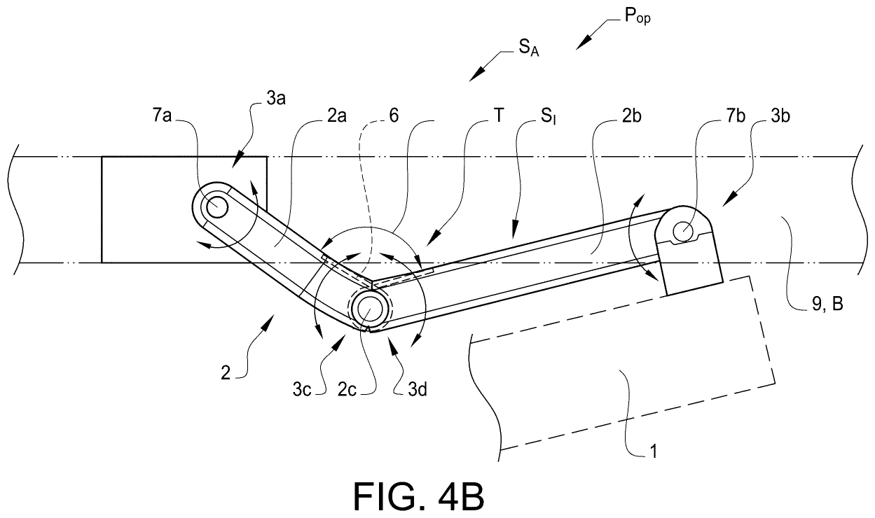

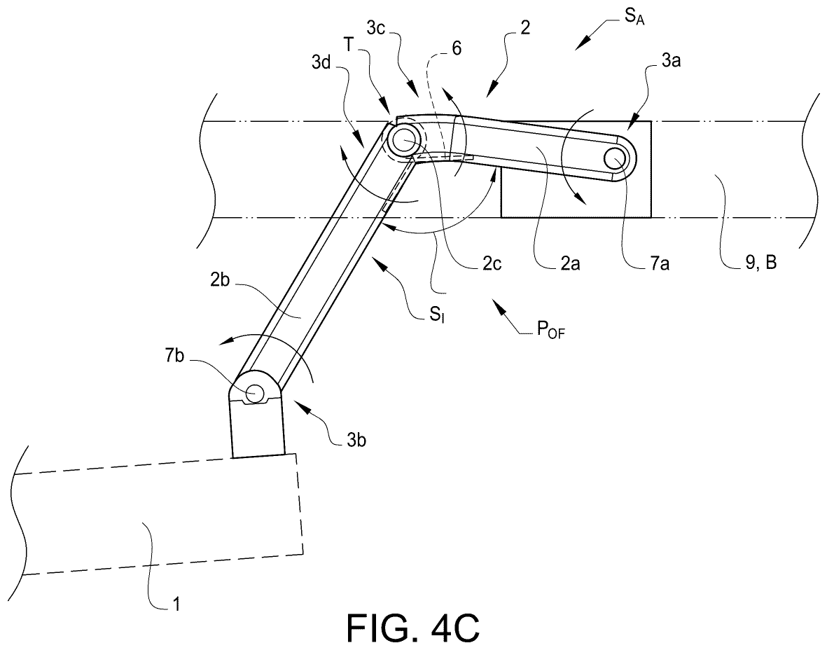

The first arm 2 is illustrated more in detail in FIGS. 4A-4C. The inner arm section 2a is extending from the first inner end 3a to the intermediate pivot point 2c, and the outer arm section 2b is extending from the intermediate pivot point 2c to the first outer end 3b. An outer end part 3c of the inner arm section 2a is pivotably connected to an inner end part 3d of the outer arm section 2b at the intermediate pivot point 2c. The pivoting function of the inner arm section 2a and the outer arm section 2b relative to each other around the intermediate pivot point 2c is schematically illustrated with arrows in FIG. 4B. Further, the pivoting configuration of the inner arm section 2a relative to the vehicle body structure B around the first inner pivot point 7a, and the pivoting configuration of the outer arm section 2b relative to the door structure 1 around the first outer pivot point 7b, are schematically illustrated with arrows in FIG. 4B. The first arm 2 is thus configured for pivoting around the first inner pivot point 7a and the first outer pivot point 7b respectively upon displacement of the door structure 1 between the closed door position P_{C} and the open door positions P_{O}, and the inner arm section 2a and the outer arm section 2b are configured for pivoting relative to each other around the intermediate pivot point 2c upon displacement of the door structure 1 between the closed door position P_{C} and the open door positions P_{O}.

The closed door position P_{C} is shown in FIGS. 2A and 3A. In the closed door position P_{C}, the inner arm section 2a and the outer arm section 2b are arranged relative to each other in an extended state SE, as understood from the figures. Upon opening of the door structure 1 from the closed door position P_{C}, the inner arm section 2a and the outer arm section 2b are pivoted relative to each other around the intermediate pivot point 2c from the extended state S_{E} to an angled state S_{A}, as shown in FIGS. 2B-2C and 3B-3C. Thus, in the open door positions P_{O}, the inner arm section 2a and the outer arm section 2b are arranged relative to each other in an angled state S_{A}, and the inner arm section 2a and the outer arm section 2b are configured for pivoting around the intermediate pivot point 2c when displaced between the extended state S_{E} and the angled state S_{A}.

The angular relationship between the inner arm section 2a and the outer arm section 2b around the intermediate pivot point 2c for different positions is schematically shown in FIGS. 4A-4C. The inner arm section 2a and the outer arm section 2b are positioned relative to each other with an angular relationship, where a relative angle α is measured between the inner arm section 2a and the outer arm section 2b on an inner side SI of the first arm 2, as shown in FIGS. 4A-4C. The inner side SI is defined as the side of the first arm 2 facing inwards in the closed door position P_{C}, as shown in FIG. 4A. In the extended state S_{E}, the angular relationship between the inner arm section 2a and the outer arm section 2b is greater than the angular relationship between the inner arm section 2a and the outer arm section 2b in the angled state S_{A}. Thus, the relative angle α measured between the inner arm section 2a and the outer arm section 2b is greater in the extended state S_{E} than in the angled state S_{A}, as understood from the figures. This angular configuration is enabling an efficient and compact displacement of the door structure 1 relative to the vehicle body structure B. The extended state S_{E} could in this way be defined as the state in which the relative angle α has its greatest value during the door opening and closing operations.

As understood from FIGS. 4A-4C, the relative angle α measured between the inner arm section 2a and the outer arm section 2b is greater in the closed door position shown in FIG. 4A compared to the partly open door position P_{OP} shown in FIG. 4B, as well as compared to the fully open door position P_{OF} shown in FIG. 4C. Thus, upon displacement of the door structure 1 from the closed door position P_{C} to the fully open door position P_{OF} via the partly open door positions P_{OP}, the outer arm section 2b is configured for being folded from the extended state S_{E} towards the inner arm section 2a around the intermediate pivot point 2c. Upon displacement of the door structure 1 from the fully open door position P_{OF} to the closed door position P_{C} via the partly open door positions P_{OP}, the outer arm section 2b is configured for being folded away from the inner arm section 2a around the intermediate pivot point 2c to the extended state S_{E}.

To support the folding movement of the outer arm section 2b and the inner arm section 2a towards each other around the intermediate pivot point 2c when the door structure 1 is displaced from the closed door position P_{C} to the open door positions P_{O}, the intermediate pivot point 2c is arranged as a spring-loaded pivoting point comprising a spring member 6, as shown in FIGS. 4A-4C. The spring member 6 is thus used for establishing the pivoting movement of the of the outer arm section 2b and the inner arm section 2a towards each other around the intermediate pivot point 2c during the door opening sequence. Upon displacement of the door structure 1 from the closed door position P_{C} to the open door positions P_{O}, the outer arm section 2b is folded towards the inner arm section 2a around the intermediate pivot point 2c by means of spring action from the spring member 6. This spring action is enabled by a spring pre-tension T of the spring member 6 that is greater in the closed door position P_{C} than in the open door positions P_{O}.

Upon displacement of the door structure 1 from the open door positions P_{O} to the closed door position P_{C} the outer arm section 2b is configured for being folded away from the inner arm section 2a around the intermediate pivot point 2c, as shown in FIGS. 4A-4C. During the door closing operation, the spring pre-tension T of the spring member 6 is built up by the movement of the door structure 1, when the first arm 2 is stretched out to the extended state S_{E}. In this way, the spring pre-tension T of the spring member 6 is built up to be greater in the closed door position P_{C} than in the open door positions P_{O} through the stretching pivoting movement of the outer arm section 2b and the inner arm section 2a relative to each other around the intermediate pivot point 2c.

It should be understood that the first inner pivot point 7a and the second inner pivot point 8a are non-slidingly arranged relative to the vehicle body structure B. The first outer pivot point 7b and the second outer pivot point 8b are non-slidingly arranged relative to the door structure 1.

As shown in FIGS. 2A-2C and 3A-3C, the lower end 1a of the door structure 1 further comprises a lower steering pin 10a arranged in connection to the first arm 2. The lower steering pin 10a is in the shown embodiment thus arranged in the lower front section of the door structure 1. The lower steering pin 10a is engaging a lower slot 11a arranged in the vehicle body structure B upon initial displacement of the door structure 1 from the closed door position P_{C} to the open door positions P_{O} and upon final displacement of the door structure 1 from the open door positions P_{O} to the closed door position P_{C}. The lower slot 11a is suitably arranged in the side sill structure 9 forming part of the vehicle body structure B.

After the initial displacement when opening the door structure 1, the lower steering pin 10a is leaving the lower slot 11a upon further opening of the door structure 1, as understood from FIGS. 2B-2C. In FIG. 2B, the lower steering pin 10a has reached an outer end of the lower slot 11a. When moving from the fully open door position P_{OF} towards the closed door position P_{C}, the lower steering pin 10a is arranged outside the lower slot 11a until a final displacement of the door structure 1 is taking place. In the position of the door structure 1 in FIG. 2B when closing the door structure 1, the lower steering pin 10a is engaging the lower slot 11a. Upon further movement of the door structure 1 towards the closed door position P_{C}, the lower steering pin 10a is guided in the lower slot 11a.

As shown in FIGS. 2A-2C, an upper end 1b of the door structure 1 further comprises an upper steering pin 10b. The upper steering pin 10b is in the shown embodiment thus arranged in the upper front section of the door structure 1. The upper steering pin 10b is configured for engaging an upper slot 11b arranged in the vehicle body structure B upon initial displacement of the door structure 1 from the closed door position P_{C} to the open door position P_{O} and upon final displacement of the door structure 1 from the open door position P_{O} to the closed door position P_{C}. The upper slot 11b is suitably arranged in an upper roof beam structure or similar structural part of the vehicle body structure B.

After the initial displacement when opening the door structure 1, the upper steering pin 10b is leaving the upper slot 11b upon further opening of the door structure 1, as understood from FIGS. 2B-2C. In FIG. 2B, the upper steering pin 10b has reached an outer end of the upper slot 11b. When moving from the fully open door position P_{OF} towards the closed door position P_{C}, the upper steering pin 10b is arranged outside the upper slot 11b until a final displacement of the door structure 1 is taking place. In the position of the door structure 1 in FIG. 2B when closing the door structure 1, the upper steering pin 10b is engaging the upper slot 11b. Upon further movement of the door structure 1 towards the closed door position P_{C}, the upper steering pin 10b is guided in the upper slot 11b.

When opening the door structure 1, the lower steering pin 10a and the upper steering pin 10b are guiding the initial opening movement of the door structure 1 when displaced from the closed door position P_{C}. In this way, the movement of the door structure is controlled through the interaction between the lower steering pin 10a and the lower slot 11a, and the interaction between the upper steering pin 10b and the upper slot 11b. The respective slots may have straight or curved configurations depending on the design and construction of the vehicle door system. The steering pins are suitably extending out from the door structure 1 for an efficient engagement with the respective slots.

The steering pins and slots are controlling the initial movement when opening the door structure 1 and the final movement when closing the door structure for securing alignment between the door structure 1 and the vehicle body structure B. The steering pins and slots are thus used for a controlled displacement of the door structure 1, and together with the pivoting movement of the inner arm section 2a and the outer arm section 2b around the intermediate pivot point 2c the movement of the door structure 1 is efficiently steered.

The steering pins and the slots may also be used for an efficient locking of the door structure 1 to the vehicle body structure B in the closed door position P_{C}, and suitable locking means may be provided for an efficient locking operation. By locking the door structure 1 via the steering pins, the number of traditional latches used for locking the door structure can be reduced.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description. Reference signs mentioned in the claims should not be seen as limiting the extent of the matter protected by the claims, and their sole function is to make claims easier to understand.

### REFERENCE SIGNS

1: Door structure
1a: Lower end
1b: Upper end
2: First arm
2a: Inner arm section
2b: Outer arm section
2c: Intermediate pivot point
3a: First inner end
3b: First outer end
3c: Outer end part
3d: Inner end part
4: Second arm
5a: Second inner end
5b: Second outer end
6: Spring member
7a: First inner pivot point
7b: First outer pivot point
8a: Second inner pivot point
8b: Second outer pivot point
9: Side sill structure
10a: Lower steering pin
10b: Upper steering pin
11a: Lower slot
11b: Upper slot
B: Vehicle body structure
S: Vehicle door system
P_{C}: Closed door position
P_{O}: Open door position
S_{A}: Angled state
S_{E}: Extended state
T: Spring pre-tension
V: Vehicle

What is claimed is:

1. A vehicle door system comprising a door structure movably arranged relative to a vehicle body structure between a closed door position and an open door position,
wherein the door structure is connected to the vehicle body structure via a first arm and a second arm, wherein the first arm and the second arm are arranged at a lower end of the door structure,
wherein the first arm comprises a first inner end pivotably connected to the vehicle body structure and a first outer end pivotably connected to the door structure,
wherein the second arm comprises a second inner end pivotably connected to the vehicle body structure and a second outer end pivotably connected to the door structure, wherein the first arm comprises an inner arm section and an outer arm section pivotably connected to each other via an intermediate pivot point, wherein the inner arm section and the outer arm section are configured for being pivotably displaced relative to each other via the intermediate pivot point upon displacement of the door structure between the closed door position and the open door position.

2. The vehicle door system according to claim 1, wherein in the closed door position, the inner arm section and the outer arm section are arranged relative to each other in an extended state, and wherein in the open door position, the inner arm section and the outer arm section are arranged relative to each other in an angled state, wherein the inner arm section and the outer arm section are configured for pivoting around the intermediate pivot point when displaced between the extended state and the angled state.

3. The vehicle door system according to claim 2, wherein in the extended state the angular relationship between the inner arm section and the outer arm section is greater than the angular relationship between the inner arm section and the outer arm section in the angled state.

4. The vehicle door system according to claim 1, wherein the intermediate pivot point is arranged as a spring-loaded pivoting point comprising a spring member.

5. The vehicle door system according to claim 4, wherein upon displacement of the door structure from the closed door position to the open door position, the outer arm section is configured for being folded towards the inner arm section around the intermediate pivot point by means of spring action from the spring member, and wherein upon displacement of the door structure from the open door position to the closed door position the outer arm section is configured for being folded away from the inner arm section around the intermediate pivot point.

6. The vehicle door system according to claim 4, wherein a spring pre-tension of the spring member is greater in the closed door position than in the open door position.

7. The vehicle door system according to claim 1, wherein the inner arm section is extending from the first inner end to the intermediate pivot point, and the outer arm section is extending from the intermediate pivot point to the first outer end.

8. The vehicle door system according to claim 1, wherein the first inner end is pivotably connected to the vehicle body structure via a first inner pivot point and the first outer end is pivotably connected to the door structure via a first outer pivot point, wherein the first arm is configured for pivoting around the first inner pivot point and the first outer pivot point upon displacement of the door structure between the closed door position and the open door position,
wherein the second inner end is pivotably connected to the vehicle body structure via a second inner pivot point and the second outer end is pivotably connected to the door structure via a second outer pivot point, wherein the second arm is configured for pivoting around the second inner pivot point and the second outer pivot point upon displacement of the door structure between the closed door position and the open door position.

9. The vehicle door system according to claim 8, wherein the first inner pivot point and the second inner pivot point are non-slidingly arranged relative to the vehicle body structure, and wherein the first outer pivot point and the second outer pivot point are non-slidingly arranged relative to the door structure.

10. The vehicle door system according to claim 1, wherein the first inner end and the second inner end are pivotably connected to a side sill structure forming part of the vehicle body structure.

11. The vehicle door system according to claim 1, wherein the first arm is arranged forwards of the second arm, or wherein the first arm is arranged rearwards of the second arm.

12. The vehicle door system according to claim 1, wherein the lower end of the door structure further comprises a lower steering pin arranged in connection to the first arm, wherein the lower steering pin is configured for engaging a lower slot arranged in the vehicle body structure upon initial displacement of the door structure from the closed door position to the open door position and upon final displacement of the door structure from the open door position to the closed door position.

13. The vehicle door system according to claim 1, wherein an upper end of the door structure further comprises an upper steering pin, wherein the upper steering pin is configured for engaging an upper slot arranged in the vehicle body structure upon initial displacement of the door structure from the closed door position to the open door position and upon final displacement of the door structure from the open door position to the closed door position.

14. A vehicle comprising the vehicle door system according to claim 1.

15. A method for operating a vehicle door system comprising a door structure movably arranged relative to a vehicle body structure between a closed door position and an open door position,
wherein the door structure is connected to the vehicle body structure via a first arm and a second arm, wherein the first arm and the second arm are arranged at a lower end of the door structure,
wherein the first arm comprises a first inner end pivotably connected to the vehicle body structure and a first outer end pivotably connected to the door structure,
wherein the second arm comprises a second inner end pivotably connected to the vehicle body structure and a second outer end pivotably connected to the door structure, wherein the first arm comprises an inner arm section and an outer arm section pivotably connected to each other via an intermediate pivot point, wherein the method comprises the step: pivotably displacing the inner arm section and the outer arm section relative to each other via the intermediate pivot point upon displacement of the door structure between the closed door position and the open door position.
